(19) United States
(12) Patent Application Publication
(10) Pub. No.: US 2011/0250321 A1
(43) Pub. Date: Oct. 13, 2011

(54) OVEN BAKED POCKET CHEESE

(76) Inventor: Kevin Frank Everhart, Westby, WI (US)

(21) Appl. No.: 13/084,727

(22) Filed: Apr. 12, 2011

Related U.S. Application Data
(60) Provisional application No. 61/323,554, filed on Apr. 13, 2010.

(51) Int. Cl. A23C 19/00

(52) U.S. Cl. 426/92; 426/89; 426/102; 426/274

(57) ABSTRACT

The present invention is directed to a baked cheese product having two opposing pieces of exterior cheese having outer edges. An interior food product of a different type of cheese or a non-cheese product has dimensions less than the dimensions of the exterior cheese. The interior food product is positioned between the opposing slices of the exterior cheese such that outer edges of the opposing slices of the exterior cheese are placed together. The outer edges are bonded by heat to create a bond sufficient to prevent leakage of the interior food product.

### CROSS-REFERENCE TO RELATED APPLICATION

The application claims priority to U.S. Provisional Application entitled “OVEN BAKED POCKET CHEESE,” Ser. No. 61/323,554, filed Apr. 13, 2010, which is incorporated herein by reference in its entirety.

### FIELD OF THE INVENTION

The present invention is directed to a baked cheese product and to a method for producing a baked cheese pocket product that can be filled with cheese or non-cheese food products to vary flavor and texture.

### DESCRIPTION OF THE PRIOR ART

Food products with “pockets” for containing other interior food products are well known in the marketplace, particularly in the pastry industry. In this case, the exterior shell of the food product contain the primary ingredients of flour, water and/or oils to make a dough structure that depends on the protein, i.e., gluten, and carbohydrates to form a pliable, flexible sheet required to surround and contain the interior filling.

Within the cheese industry, there are some layered cheese products known to the industry. Examples of these cheeses include Double Gloucester with Stilton, known as Huntsman; Five Counties with single layers of Double Red Leicester, Cheshire, Derby & Somerset Cheddar, Five Ridings, made of layers of Leicester, Gloucester, Cheddar, Cheshire & Derby; and Stripey Jack. However, none of these cheeses are bonded completely and all are comprised of melting cheeses. These cheeses primarily serve as table cheeses or appetizers, and not as entries or side dishes. When heated, these cheeses are typically known to melt or soften to a molten consistency. While this may be desirable in hot food products requiring melted cheese, such as pizza, quesadillas, nachos or the like, there are times when shape retention for cheese is desired such as when the cheese product is baked or pan fried. In these situations, it is important to maintain some integrity or retention in shape. Typically, these types of cheese can form a meal in themselves without the need for other products, e.g., pizza dough and chips.

However to date, there has not been shown to be a baked cheese product which includes an interior layer of another cheese or another type of filling.

### SUMMARY OF THE INVENTION

The present invention is directed to a baked cheese product, comprising two opposing slices of exterior cheese having outer edges, wherein the exterior cheese has a pH between about 5.9 and 6.5, and a moisture content between about 30% and 50%. The baked cheese product further comprises an interior food product having a dimension less than the dimensions of the exterior cheese; wherein the interior food product is positioned between the opposing slices of the exterior cheese such that outer edges of the opposing slices of the exterior cheese are placed together; wherein the outer edges are heat bonded sufficiently to prevent the interior food product from leaking beyond the opposing slices of the exterior cheese.

The present invention is further directed to a process for producing a baked cheese pocket product that can be filled with cheese or non-cheese food products to vary flavor and texture, comprising forming a cheese pocket product comprising two opposing slices of exterior cheese having outer edges and a specific dimension, wherein the exterior cheese includes the following characteristics: a pH between about 5.9 and 6.5 and a moisture content between about 30% and 50%; and an interior food product having dimensions less than the dimensions of the exterior cheese; wherein the interior food product is positioned between the opposing slices of the exterior cheese such that outer edges of the opposing slices of the exterior cheese are placed together; and heating the cheese pocket product to a temperature sufficient to bond the outer edges sufficiently to prevent the interior food product from leaking beyond the opposing slices of the exterior cheese.

The present invention satisfies a market preference for cheeses with unique flavor and texture profiles. The cheese product of the present invention allows for the ability to alter the flavor profile of cheese by adding other cheeses or non-cheese fillings inside a bonded baked cheese pocket.

Advantageously, the present invention solves a prior art problem with the interior “filling” leaking from the sides of the exterior product under the heating step that is required in the prior formulation. This problem was solved by developing and using a special cheese product with unique characteristics causing the edges of the exterior sides of the cheese to bond during the baking process in order to create a genuine “pocket” for the filling.

The product of the present invention is nutritionally beneficial over other pocket foods in that it provides an excellent source of calcium, protein and it is also gluten-free. The cheese product of the present invention is adaptable to all food service products and can be served as a breakfast food, appetizer, entree, side dish or dessert.

Another advantage of the pocket cheese of the present invention is that it is typically thinner than other cheese products, and specifically “bread cheese” products, which allows for more caramelization of the product. The combination of the baked exterior, the thinner appearance and the caramelization creates a better flavored product.

The objects and advantages of the invention will appear more fully from the following detailed description of the preferred embodiment of the invention made in conjunction with the accompanying drawings.

### BRIEF DESCRIPTION OF THE DRAWINGS AND ATTACHMENT

FIG. 1 is a perspective view of the oven baked cheese product of the present invention.

FIG. 2 is an exploded perspective view of the cheese product of FIG. 1.

FIG. 3 is a perspective view of the cheese product of FIG. 1 with one exterior cheese side missing.

### DETAILED DESCRIPTION OF THE INVENTION

The invention is a method for producing a baked cheese pocket and the baked cheese product itself. The cheese product of the present invention can be stuffed with cheese or non-cheese food products to vary flavor and texture. Advantageously, the differences create a new family of pocket-stuffed baked cheese products.

### Exterior Cheese

The exterior cheese pocket is produced by two heat bonded or annealed slices of exterior cheese which, when bonded together, form an interior pocket which contains an interior product of a different kind of cheese or a non-cheese filler as discussed below. An important feature of the cheese product of the present invention is that outer edges of the exterior slices of cheese are bonded together to trap the interior product to prevent any leakage.

A desirable characteristic of the exterior cheese is that it cannot melt on heating. Rather, heating the cheese should stiffen it and dry it. In addition, adjacent slices of the exterior cheese must have the ability to anneal together to form a seal. Cheese which is curdled by acid, not rennet, is preferred. Without wishing to be held to any particular theory for this, it is believed that rennet creates a malleable structure of large casing micelles held together by relatively few calcium atoms and hydrophobic bonds, which is weakened by heat. Acid, on the other hand, dissolves the calcium glue that holds the casing proteins together in micelles. Accordingly, it eliminates the protein's negative electrical charge, which would otherwise cause the proteins to repel each other. The proteins are then free to bond. Thus when cheese curdled by acid is heated, water and not the cheese proteins is removed by boiling away. The exterior cheese product dries further and concentrates the proteins causing the adjacent slices to bond together to form a seal preventing the interior food product from leaking out. Reference is made to McGee, Harold, 2004, On Food and Cooking—the Science and Allure of the Kitchen, Scribner, pp. 61-62 for a discussion of this concept.

The exterior cheese therefore has some unique characteristics to give it the ability to form a bonded product. In general, the exterior cheese is typically made with milk, salt and enzymes in the absence of any cheese starter cultures. A required step in cheese making usually involves separating the milk into solid curds and liquid whey. This is typically accomplished by acidifying (or souring) the milk and adding rennet. Typically, a cheese starter culture is necessary to assist the beginning of the acidification or fermentation process necessary to culture cheese. A starter bacterium is usually derived from the Lactococci, Lactobacilli or Streptococci families. However, the acidification can also be accomplished directly by the addition of an acid-like vinegar, or by the addition of rennet in slightly higher proportions. Normal cheese making procedures, known to the art, are followed with the exception that the cheese or whey does not build acid due to the lack of starter culture which results in the pH of the cheese being higher. The preferred content and characteristics of the exterior cheese portion of the present invention are as follows:
pH: between about 5.9 and 6.5;
Moisture content: between about 30% and 50%, preferably between about 38% and 43%;

A preferred cheese for use in the present invention is Juustoleipä\ddot{,} otherwise known as “bread cheese.” Juustoleipä cheese is a fresh cheese traditionally made from cow's colostrum, rich milk from a cow that has recently calved. Reindeer or even goat milk can also be used. Juustoleipä cheese typically has a moisture content between 39% and 44%.

Juustoleipä cheese has several advantages over standard cheese. This cheese is more difficult to melt and has a gluten-free, carbohydrate-free dairy protein structure which provides a thin, flexible medium to formulate pockets to hold fillings of various types. In addition, Juustoleipä cheese provides a secure bond, when two slices of the cheese are baked together, to contain the filling when the outer layers of the cheese are bonded together by a baking process.

The structure of the cheese is of a mild, fresh, buttery cheese with a relatively high pH, non-acidic formulation which provides an elastic network of protein “bands” that keeps the cheese flexible, stable, and squeaky, which is ideal for a frying-toasting-baking cheese which can accommodate fillings and can also be heated within, without losing the filling, because the cheese can be re-bonded or meshed because of the elastic protein and butter fat.

Juustoleipä cheese has a relatively high pH, which increases its resistance to melting when heated. The use of this higher pH cheese enables the baking of the cheese pockets and the resealing of the edges, i.e., bonding the cheese slices, without losing the integrity of the pocket or the shape of the final product. Other “baked cheeses” can also be used to create the exterior pocket. Two baked cheese types other than Juustoleipä that could be used are Queso Para Freir, a Hispanic type baked cheese, and Halloumi, a baked cheese type originally from Cyprus, both having functionality similar to Juustoleipä.

### Interior Filler Product

The interior filler product is designed to fill the pocket formed by the bonding of the edges of the exterior cheese slices. A preferred interior filler product is a slightly smaller version of the exterior cheese which can be used as the interior or center cheese filling. The center cheese can be made of a number of different cheeses from the exterior cheese, including cheddar, Swiss, and mozzarella to name a few. The center cheese can also have a different moisture content from the exterior cheese.

It is also within the scope of the present invention to fill the pocket with non-cheese food products, including but not limited to, jams, jellies, dried fruit, fruit roll ups, meat or meat products, various sauces, peppers, herbs, spices, vegetables and combinations of these.

### Process for Making the Cheese Product

The typical process for preparing the exterior cheese to produce the pocket cheese of the present invention is to cut and shape the exterior cheese slice from a standard forty pound block of exterior cheese as described above, typically measuring 11″×14″×7″, into six loaves measuring approximately 11 inches by 4.66 inches by 3.5 inches.

Each loaf of cheese is then cut into multiple slices, preferably having a height of about 3.5 inches, a width of about 4.66 inches and a depth between 0.125 inches and 1.00 inches with a preferred depth of 0.25 inches.

When the pocket of the cheese product is going to be filled with cheese, the interior cheese is created from a forty pound block of cheese and cut into ten loaves, typically measuring about 2.8 inches by 3.5 inches by 11 inches (or similar dimensions if cut from a wheel or other shaped cheese). The loaves are then cut into slices, typically measuring about 2.8 inches by 3.5 inches with a weight of approximately one to two ounces. This creates an ideal size for the interior cheese slice to be placed within the pocket comprising a bottom layer and a top layer of the exterior cheese slice.

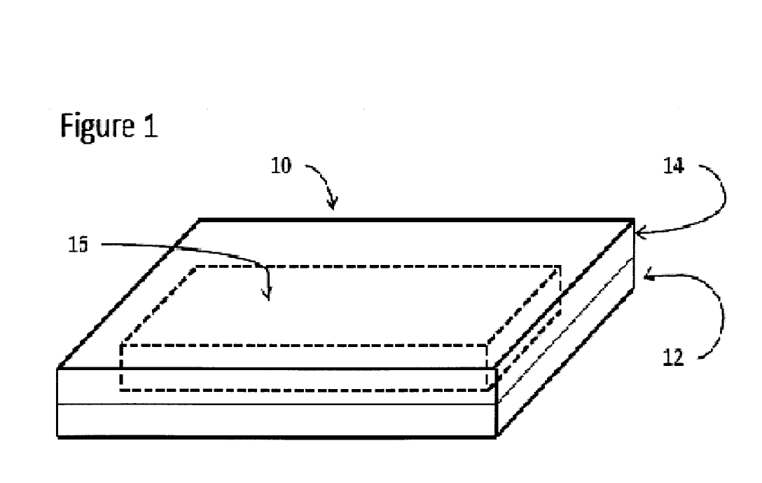

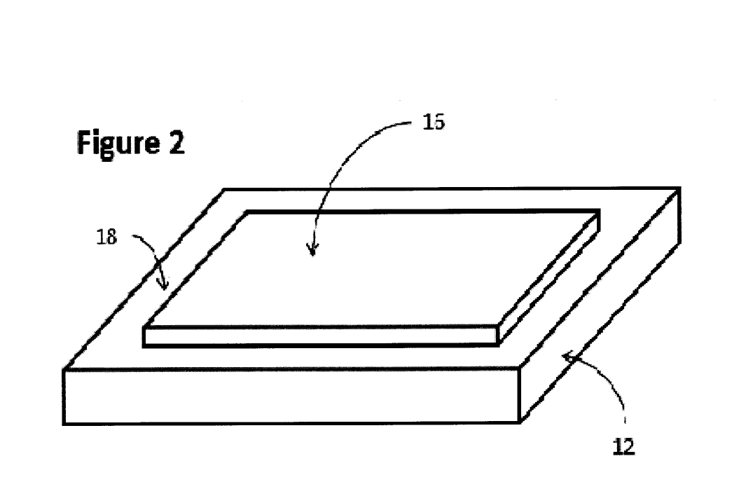

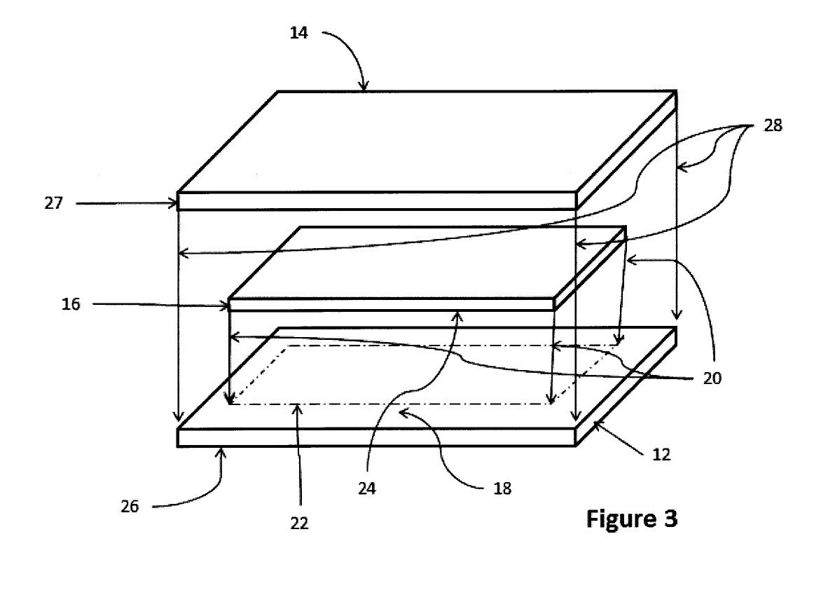

Referring now to FIGS. 1 and 2, oven baked cheese product 10 of the present invention is comprised of a lower or first exterior cheese slice 12 aligned with a similarly sized upper or second exterior cheese slice 14 with a smaller interior filler product 16 situation there between. For purposes of describing the figures, it will be assumed that the smaller interior filler product 16 is a slice of cheese. Referring to FIGS. 2 and 3, the interior cheese slice 16 is placed upon the bottom layer exterior cheese slice 12 along arrows 20 to the margin 22 leaving the frame 18 of a suitable distance, typically about ⅜ inch; between the edge 24 of the inner cheese slice 16 and the edge 26 of the exterior slice 12. It is within the scope of the present invention to prepare cheese products 10 having shapes other than the rectangular shape illustrated in the figures. For example a circular or oval shape, not illustrated, can also be used.

Regardless of the exterior cheese shape, the interior cheese slice 16 or non-cheese product is covered with a upper or second exterior cheese slice 14 having the same or similar dimensions as the lower slice 12 of exterior cheese, as illustrated in FIGS. 1 and 3, along lines 28, illustrated in FIG. 3. The final pocket cheese product 10, illustrated in FIG. 1, is then placed on a baking sheet (not shown).

As described above, an alternative to the interior cheese product 16 is a non-cheese food product, including but not limited to, jam, jellies, dried fruit, fruit roll ups, meat or meat products, various sauces, peppers, herbs, spices or vegetables.

After the upper exterior cheese slice 14 is placed on the lower exterior cheese slice 12, which also includes interior cheese slice 16 or non-cheese food product, as illustrated in FIG. 1, the entire pocket cheese product 10 is placed in an oven at a temperature and a time sufficient to seal the exterior cheese slices 12 and 14 at the frame 18 and to caramelize or brown the pocket cheese product 10. There are a variety of ovens that can be used for this purpose, including deck ovens, impingement ovens and infrared ovens. While any of these ovens will accomplish the purpose, an impingement oven is preferred. An impingement oven is a type of oven that uses mostly convection to heat the pocket cheese product as well as some heat of conduction. In particular, an air impingement oven is preferred as it uses hot air under pressure which surrounds the cheese with small jets of hot air for rapid uniform heating. A non-convection type oven or a conventional oven could also be used; however, heating times would increase, which might result in a less uniform product.

Depending upon the type of oven and other conditions, the temperature of the oven can range from about 400 degrees F. to about 1000 degrees F., preferably about 400 degrees F. to about 540 degrees F., and most preferably about 450 degrees F. Generally, a time between about 2 and 10 minutes, preferably 3 and 6 minutes, is sufficient to accomplish this step.

The step of sealing the two exterior cheese slices 12 and 14 depends upon the thickness of the interior cheese slice 16 or the non-cheese food product and the intensity of the browning on the exterior surfaces of the pocket cheese product 10 desired. The baking process also creates a “bonding” at the edges 26 and 27 of the exterior cheese slices 12 and 14, which is required to seal the exterior cheese layers 12 and 14, to prevent leakage of the interior cheese product 16 or non-cheese food product.

After the pocket cheese product 10 has sufficiently baked, the baking sheet is removed from the oven and placed upon racks to cool.

After the cheese is cooled to more-or-less room temperature, e.g., about 65-80 degrees F., or cooler, about 36-42 degrees F., the individual pocket cheese product pieces are sealed and packaged to prevent spoilage. A preferred method for doing this is to place the pocket cheese into a CRYOVAC shrink bag (Cryovac Food Packaging Systems, Duncan, S.C.), vacuum sealed, labeled and boxed. The product can either be frozen or refrigerated. Preferably, the product is kept under refrigeration at a temperature between about 34 to 40 degrees F.

The final pocket cheese product 10 is an oven baked pocket cheese created by layering and filling a “pocket” 16 within two exterior cheese slices 12 and 14. Preferably, the final pocket cheese product has a total thickness not greater than 1 inch.

The end user of the pocket cheese product would heat the cheese until it glistens. The product can be warmed in a microwave set on high for between 30 seconds and 1 minute, on the stove top in a skillet on medium heat for 4 minutes per side, in the oven set at around 375 degrees F. on a pan for 20 minutes or on the grill on foil for 5 to 10 minutes. The product can be consumed as a snack, appetizer, side dish or complete meal.

Any version of any component or method step of the invention may be used with any other component or method step of the invention. The elements described herein can be used in any combination whether explicitly described or not.

All combinations of method steps as used herein can be performed in any order, unless otherwise specified or clearly implied to the contrary by the context in which the referenced combination is made.

As used herein, the singular forms “a,” “an,” and “the” include plural referents unless the content clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference in their entirety to the same extent as if each individual reference were specifically and individually indicated as being incorporated by reference. In case of conflict between the present disclosure and the incorporated references, the present disclosure controls.

The devices, methods, compounds and compositions of the present invention can comprise, consist of, or consist essentially of the essential elements and limitations described herein, as well as any additional or optional steps, ingredients, components, or limitations described herein or otherwise useful in the art.

While this invention may be embodied in many forms, what is described in detail herein is a specific preferred embodiment of the invention. The present disclosure is an exemplification of the principles of the invention is not intended to limit the invention to the particular embodiments illustrated. It is to be understood that this invention is not limited to the particular examples, process steps, and materials disclosed herein as such process steps and materials may vary somewhat. It is also understood that the terminology used herein is used for the purpose of describing particular embodiments only and is not intended to be limiting since the scope of the present invention will be limited to only the appended claims and equivalents thereof.

What is claimed is:

1) A baked cheese product, comprising:
a) two opposing slices of exterior cheese having outer edges, wherein the exterior cheese has the following characteristics:
i) a pH between about 5.9 and 6.5; and
ii) a moisture content between about 30% and 50%; and
b) an interior food product having a dimension less than the dimensions of the exterior cheese; wherein the interior food product is positioned between the opposing slices of the exterior cheese such that outer edges of the opposing slices of the exterior cheese are placed together.

2) The baked cheese product of claim 1 wherein the outer edges have been heat bonded to a temperature sufficient to seal the outer edges of the opposing slices of the exterior cheese.

3) The baked cheese product of claim 1 wherein the moisture content of the exterior cheese is between about 38% and 43%.

4) The baked cheese product of claim 1 wherein the exterior cheese is selected from the group including Juustoleipä cheese, Queso Para Freir cheese and Halloumi cheese.

5) The baked cheese product of claim 1 wherein the exterior cheese is Juustoleipä\ddot{}cheese.

6) The baked cheese product of claim 1 wherein the baked cheese product has a total thickness no greater than approximately 1 inch.

7) The baked cheese product of claim 1 wherein the interior food product is an interior cheese wherein the interior cheese is a different type from the exterior cheese.

8) The baked cheese product of claim 1 wherein the interior cheese is selected from the group including cheddar cheese, Swiss cheese and mozzarella cheese.

9) The baked cheese product of claim 1 wherein the interior food product is selected from the group comprising jam, jellies, dried fruit, fruit roll ups, meat or meat products, various sauces, peppers, herbs, spices and vegetables.

10) A process for producing a baked cheese pocket product that can be filled with cheese or non-cheese food products to vary flavor and texture, comprising:
a) forming a cheese pocket product comprising two opposing slices of exterior cheese having outer edges and a specific dimension, wherein the exterior cheese includes the following characteristics: a pH between about 5.9 and 6.5 and a moisture content between about 30% and 50%; and an interior food product having dimensions less than the dimensions of the exterior cheese; wherein the interior food product is positioned between the opposing slices of the exterior cheese such that outer edges of the opposing slices of the exterior cheese are placed together; and
b) heating the cheese pocket product to a temperature sufficient to bond the outer edges sufficiently to prevent the interior food product from leaking beyond the opposing slices of the exterior cheese.

11) The process of claim 10 wherein the outer edges have been heat bonded to a temperature sufficient to bond the outer edges of the opposing slices of the exterior cheese.

12) The process of claim 10 wherein the moisture content of the exterior cheese is between about 38% and 43%.

13) The process of claim 10 wherein the exterior cheese is selected from the group including Juustoleipä cheese, Queso Para Freir cheese and Halloumi cheese.

14) The process of claim 10 wherein the exterior cheese is Juustoleipä cheese.

15) The process of claim 10 wherein the product has a height no greater than approximately 1 inch.

16) The process of claim 10 wherein the interior food product is selected from the group comprising a different type of cheese from the exterior cheese, jam, jellies, dried fruit, fruit roll ups, meat or meat products, various sauces, peppers, herbs, spices and vegetables and combinations thereof.

17) The process of claim 10 wherein the baked cheese pocket product has been baked to a temperature between about 400 and 540 degrees F. for a time between approximately 3 and 6 minutes.

18) A baked cheese product, comprising:
a) two opposing slices of exterior cheese having outer edges, wherein the exterior cheese has the following characteristics:
i) a pH between about 5.9 and 6.5; and
ii) a moisture content between about 38% and 43%; and
b) an interior food product having a dimension less than the dimensions of the exterior cheese; wherein the interior food product is positioned between the opposing slices of the exterior cheese such that outer edges of the opposing slices of the exterior cheese are placed together; wherein the outer edges have been heat bonded to a temperature sufficient to seal the outer edges of the opposing slices of the exterior cheese.

19) The baked cheese product of claim 18 wherein the exterior cheese is selected from the group including Juustoleipä cheese, Queso Para Freir cheese and Halloumi cheese.

20) The baked cheese product of claim 18 wherein the interior food product is selected from the group consisting of an interior cheese wherein the interior cheese is a different type from the exterior cheese, jam, jellies, dried fruit, fruit roll ups, meat or meat products, various sauces, peppers, herbs, spices and vegetables.
